(19) United States
(12) Patent Application Publication
(10) Pub. No.: US 2025/0178447 A1
(43) Pub. Date: Jun. 5, 2025

(54) CONTROLLER FOR ELECTRIC VEHICLE

(71) Applicant: TOYOTA JIDOSHA KABUSHIKI KAISHA, Toyota-shi Aichi-ken (JP)

(72) Inventor: Kazuya OKUMURA, Mishima-shi Shizuoka (JP)

(73) Assignee: TOYOTA JIDOSHA KABUSHIKI KAISHA, Toyota-shi Aichi-ken (JP)

(21) Appl. No.: 18/958,734

(22) Filed: Nov. 25, 2024

(30) Foreign Application Priority Data
Dec. 1, 2023 (JP) 2023-204038

(51) Int. Cl. B60L 7/18

(52) U.S. Cl. CPC B60L 7/18; B60L 2240/421; B60L 2240/461; B60L 2240/647

(57) ABSTRACT

A controller, which is for an electric vehicle for executing anti-lock control for suppressing a lock of a wheel by controlling a braking force using a hydraulic braking force by a hydraulic brake device and a regenerative braking force by a motor, controls to set a first state where the regenerative braking force is controlled by speed feedback control in which a hydraulic pressure of the hydraulic brake device, during execution of the anti-lock control, is set constant and a speed of the wheel is controlled to follow a target speed, determines whether a road surface resistance is lower than a predetermined value during the control to the first state, and reduces, when determining that the road surface resistance is lower than the predetermined value in the first state, the hydraulic pressure of the hydraulic brake device while controlling the regenerative braking force by the speed feedback control.

### CROSS-REFERENCE TO RELATED APPLICATION(S)

The present application claims priority to and incorporates by reference the entire contents of Japanese Patent Application No. 2023-204038 filed in Japan on Dec. 1, 2023.

### BACKGROUND

The present disclosure relates to a controller for an electric vehicle.

Japanese Laid-open Patent Publication No. H06-171490 discloses an electric vehicle equipped with an anti-lock brake system (ABS) for executing anti-lock control using a hydraulic brake and a regenerative brake. In the configuration described in Japanese Laid-open Patent Publication No. H06-171490, when the anti-lock control is executed, the braking force of the regenerative brake is decreased to the decrease limit while the braking force of the hydraulic brake is maintained, and when the braking force of the regenerative brake is decreased to the decrease limit, the braking force of the hydraulic brake starts to decrease.

### SUMMARY

There is a need for providing a controller for an electric-powered vehicle that can ensure running stability by suppressing delays in reduction in braking force even when road surface drag drops during ABS operation.

According to an embodiment, a controller for an electric vehicle for executing anti-lock control for suppressing a lock of a wheel by controlling a braking force applied to the wheel using a hydraulic braking force by a hydraulic brake device and a regenerative braking force by a motor, controls to set a first state where the regenerative braking force is controlled by speed feedback control in which a hydraulic pressure of the hydraulic brake device, during execution of the anti-lock control, is set constant and a speed of the wheel is controlled to follow a target speed, determines whether a road surface resistance is lower than a predetermined value during the control to the first state, and reduces, when determining that the road surface resistance is lower than the predetermined value in the first state, the hydraulic pressure of the hydraulic brake device while controlling the regenerative braking force by the speed feedback control.

### BRIEF DESCRIPTION OF THE DRAWINGS

FIG. 1 is a diagram schematically illustrating an electric vehicle according to an embodiment;

FIG. 2 is a time chart illustrating when a road surface drag does not change when ABS operates;

FIG. 3 is a diagram for explaining a decompression reference speed;

FIG. 4 is a time chart illustrating when the road surface drag drops during the ABS operation;

FIG. 5 is a diagram for explaining that the lock amount of the wheel is increased;

FIG. 6 is a flowchart illustrating a wheel speed control;

FIG. 7 is a diagram for explaining a control state corresponding to a magnitude of a regenerative braking force.

FIG. 8 is a diagram for explaining a case where a maximum regeneration is small.

FIG. 9 is a flowchart illustrating wheel speed control according to a modification.

### DETAILED DESCRIPTION

In the related art, when ABS operates, the magnitude of braking force must be controlled according to the road surface resistance, because the road surface resistance changes according to the progress of vehicles. For example, if the road surface resistance decreases, it is necessary to increase the amount of reduction in braking force. However, if the road surface resistance is lowered in the configuration described in Japanese Laid-open Patent Publication No. H06-171490, since the braking force of the regenerative brake starts to decrease the braking force of the hydraulic brake after reaching the reduction limit, the reduction of the braking force is delayed, the amount of lock of the wheels is increased, there is a possibility that the running stability of the vehicle is deteriorated.

Hereinafter, a controller for an electric vehicle according to an embodiment of the present disclosure will be specifically described. Note that the present disclosure is not limited to the embodiments described below.

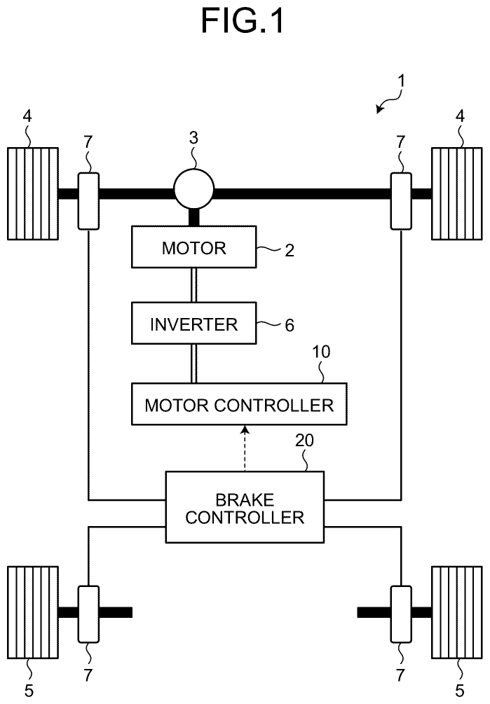

FIG. 1 is a diagram schematically illustrating an electric vehicle in the embodiment. The electric vehicle 1 includes a motor 2, a differential gear 3, front wheels 4, rear wheels 5, an inverter 6, a wheel speed sensor 7, a motor controller 10, and a brake controller 20. The controller of the electric vehicle 1 is configured to include the motor controller 10 and the brake controller 20. The electric vehicle 1 is a front-wheel drive vehicle equipped with the motor 2 as a power source, the front wheels 4 are drive wheels, the rear wheels 5 are driven wheels. The motor 2 is connected to the front wheels 4 to be capable of transmitting power through the differential gear 3.

The motor 2 is a motor generator that can function as an electric motor and a generator. When the electric vehicle 1 travels, the power output from the motor 2 is transmitted to the left and right front wheels 4 through the differential gear 3. During regenerative braking, the regenerative braking force by the motor 2 acts on the left and right front wheels 4. The motor 2 is electrically connected to the battery via the inverter 6.

The motor controller 10 is an electronic controller for controlling the motor 2. The motor controller 10 is configured to include a microcomputer with a CPU, a RAM, a ROM and input/output interfaces. The motor controller 10 performs signal-processing according to a program previously stored in ROM. signals from various sensors mounted on the electric vehicle 1 are input to the motor controller 10. For example, a motor rotation speed sensor of the electric vehicle 1, a signal from the wheel speed sensor 7 for detecting the speed of the wheel is input to the motor controller 10. The motor controller 10 executes various control based on signals input from various sensors. The motor controller 10 performs speed feedback control. The motor controller 10 outputs a control signal to the inverter 6 for controlling the motor 2 with speed feedback control. The motor controller 10 controls the torque of the motor 2 so that the rotational speed of the motor 2 follows the target speed.

Each wheel of the electric vehicle 1 is provided with a brake device. The brake equipment is a hydraulic friction brake, and the braking force changes according to the hydraulic pressure. The braking force by the brake device (hereinafter, referred to as hydraulic braking force) is controlled by the brake controller 20. In this description, the brake device configured by the hydraulic friction brake is described as a hydraulic brake.

The brake controller 20 is an electronic controller for controlling the braking force of the electric vehicle 1. The brake controller 20 is similar to the motor controller 10 as hardware. The brake controller 20 is inputted signals from various sensors mounted on the electric vehicle 1. For example, a signal from the wheel speed sensor 7 provided in each wheel is input to the brake controller 20. The brake controller 20 executes various controls based on the input signal.

The brake controller 20 controls the hydraulic braking force by the hydraulic brake device, and controls the regenerative braking force by the motor 2. From the brake controller 20, a control signal for controlling the hydraulic brake device of each wheel is output to each hydraulic brake device. During regenerative, a braking control signal for controlling the motor 2 is output from the brake controller 20 to the motor controller 10. The brake controller 20, when controlling the motor 2, outputs a control signal to the motor controller 10. The motor controller 10 controls the torque and the rotational speed of the motor 2 based on the control signal input from the brake controller 20. The brake controller 20 controls the regenerative braking force by the motor 2 in addition to the hydraulic braking force by each hydraulic brake device.

When braking the electric vehicle 1 using the regenerative braking force of the motor 2 and the hydraulic braking force of the hydraulic braking device, the brake controller 20 performs anti-lock control to avoid the wheels from locking. The brake controller 20 executes anti-lock control at the time of braking, and controls the braking force applied to the wheels by using the hydraulic braking force by the hydraulic brake device and the regenerative braking force by the motor 2 to suppress the lock of the wheels. The brake controller 20 has a function as an anti-lock braking system (ABS). Incidentally, it is synonymous with ABS operation time and the anti-lock control time.

The braking controller 20 detects the locking tendency of the wheels based on the wheel velocity and determines whether or not to activate ABS. The brake controller 20 controls the wheels that tend to lock so that their wheel speeds follow the target wheel speeds when performing anti-lock control.

Specifically, the brake controller 20 calculates the target speed when ABS is operated, makes the wheel speed follow the target speed with high accuracy only by the speed feedback control of the regeneration of the motor controller 10, and controls so that the decompression of the hydraulic brake device is not operated. The speed feedback control of regeneration is a feedback control of the motor rotation speed, and controls the regenerative braking force so that the motor rotation speed follows the target speed. Only the speed feedback control of regeneration means that only the regenerative braking force is varied by keeping the hydraulic braking force constant when the braking force of the wheel is changed when ABS is operated, and that the variation of the regenerative braking force is performed by the feedback control of the motor rotational speed.

When the road surface drag is constant during ABS operation, the brake controller 20 makes the hydraulic pressure of the hydraulic brake device constant and controls the regenerative braking force by speed feedback control of regeneration to make the wheel speed follow the target speed. On the other hand, when the road surface drag drops when ABS is in operation, the reduction in the braking force of the wheel is required, but the reduction in the regenerative braking force alone may cause the wheel locking. Therefore, the depressurization of the hydraulic braking device needs to be activated. Therefore, the brake controller 20 sets a reference speed for implementing the pressure reduction of the hydraulic brake device when ABS is operated (hereinafter, referred to as a decompression reference speed). The brake controller 20 sets the decompression reference speed to a small speed to the wheel lock side with respect to the target wheel speed. When the wheel speed is equal to or less than the decompression reference speed when ABS is activated, the brake controller 20 performs decompression of the hydraulic brake device. The brake controller 20 is configured to operate the pressure reduction of the hydraulic brake device without delay only when the road surface resistance decreases and the wheel slip increases.

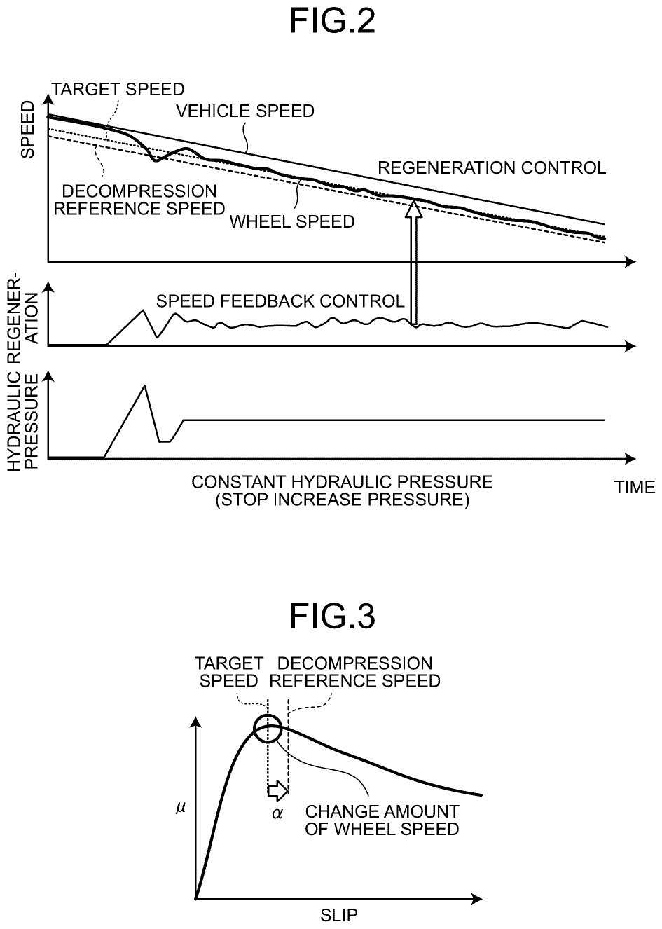

FIG. 2 is a time chart diagram illustrating a situation in which the road surface drag does not change when ABS is operated. As illustrated in FIG. 2, the brake controller 20 causes the wheel speed to follow the target speed by the speed feedback control of regeneration. During ABS operation, the brake controller 20 does not generate as much as possible the pressure increase or decrease of the hydraulic pressure of the hydraulic brake device, and controls the hydraulic pressure of the hydraulic brake device to a constant hydraulic pressure to compensate for the shortage of the regenerative braking force. This control value of the hydraulic pressure (the value of the constant hydraulic pressure) is set in accordance with the road surface resistance, and is determined to be a value proportional to the magnitude of the road surface resistance. When ABS is operated, the brake controller 20 stops the boosting of the hydraulic brake device when the regenerative braking force is smaller than the maximum regenerative force capable of outputting, and the motor speed control of the motor controller 10 is used to control the slippage of the wheel with high accuracy to the target speed near the maximum of the road surface resistance.

As illustrated in FIG. 3, the target speed of the wheel speed is set near the peak of the road surface resistance. The decompression reference speed is set at a speed offset from the target speed to the wheel slip side. The offset amount is a predetermined value α. The predetermined value x is set to a value greater than or equal to the variation of the wheel velocity when the road surface drag does not change during ABS operation. The brake controller 20 sets the decompression reference speed to a speed that is offset to the wheel lock side with respect to the target speed of the motor rotation speed. The amount of offset is a predetermined value x, and is equal to or greater than the amount of speed variation during motor speed control. The brake controller 20 sets the decompression reference speed smaller than the target speed of the regenerative control. As described above, since the decompression reference speed is set to the wheel lock side rather than the variation in the motor rotation speed, when the road surface resistance does not change, the wheel speed does not decrease to the decompression reference speed, and the decompression of the hydraulic brake device does not occur. Thus, the hydraulic braking force by the hydraulic brake device does not fluctuate and does not deteriorate the controllability of the wheel slip by the motor 2.

The brake controller 20 presets the desired slip rate. The wheel slip rate is determined based on the wheel speed and the body speed. The brake controller 20 can be set in advance the slip rate road surface resistance is estimated to be near the maximum. The braking controller 20 controls the slip rate of the wheels on which ABS operates to be within a preset slip rate. The brake controller 20 calculates the target speed of the wheel based on the vehicle speed and the slip ratio. The brake controller 20 sets the target speed of the motor 2 using the target speed of the wheel to realize the target speed of the wheel. By following the motor rotation speed to the target speed using the motor speed control based on the target speed from the brake controller 20, the motor controller 10 makes it possible to follow the wheel speed to the target speed.

The brake controller 20 calculates the target speed of the motor 2 using the wheel speed of the front wheel 4 to which the motor 2 is connected. The brake controller 20 detects the wheel speed of the front wheel 4 based on a signal input from the wheel speed sensor 7. For example, the brake controller 20 sets the average value of the control target value of the left and right front wheels 4 to the motor target speed. The motor target speed is output from the brake controller 20, and the motor controller 10 controls the torque of the motor 2 in order to realize the motor target speed.

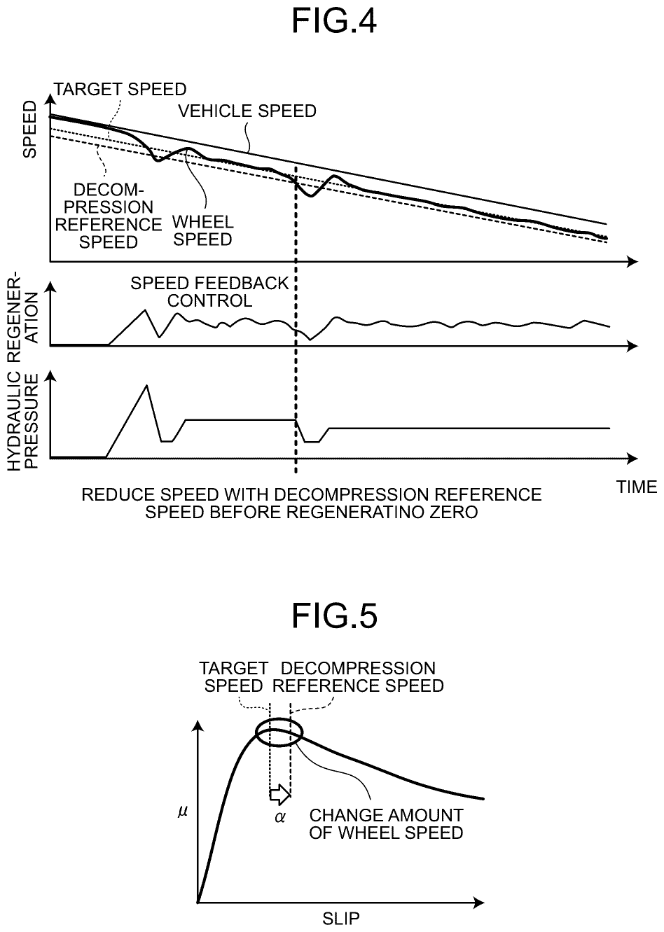

FIG. 4 is a time chart illustrating when the road surface drag drops during ABS operation. As illustrated in FIG. 4, a large variation in wheel speed occurs due to a decrease in road surface resistance, and the wheel speed reaches the decompression reference speed on the wheel lock side. As illustrated in FIG. 5, when the amount of change in the wheel speed increases due to a large slip of the wheel and the wheel speed reaches the decompression reference speed, the brake controller 20 starts decompression of the hydraulic brake device. The amount of variation of the wheel speed on the slip side with respect to the target speed represents the amount of lock of the wheels. Since the brake controller 20 starts the pressure reduction of the hydraulic brake device when the wheel speed is equal to or less than the decompression reference speed, the brake controller starts the pressure reduction of the hydraulic brake device before the regenerative braking force becomes zero (decrease limit).

When the brake controller 20 reduces the pressure of the hydraulic brake device by lowering the road surface resistance, the control value of the hydraulic pressure for controlling the constant hydraulic pressure is set again. Since the control value of the hydraulic pressure is set to a value proportional to the magnitude of the road surface resistance, the control value of the hydraulic pressure set after the decrease of the road surface resistance becomes a value lower than the control value of the hydraulic pressure set before the decrease of the road surface resistance. After the road surface drag drops during ABS operation, the brake controller 20 maintains the hydraulic pressure constant based on the control value of the hydraulic pressure that is set again, and causes the wheel speed to follow the target speed with high accuracy by speed feedback control of regeneration by the motor controller 10.

Thus, if the road surface drag decreases when ABS operates, it is possible to accelerate the return from the wheel-lock by starting the depressurization of the hydraulic braking device prior to the reduction limit of the regenerative braking force. Thus, the amount of wheel lock can be suppressed to be smaller than in the case where the hydraulic pressure of the hydraulic brake device is reduced after the regenerative braking force reaches the reduction limit.

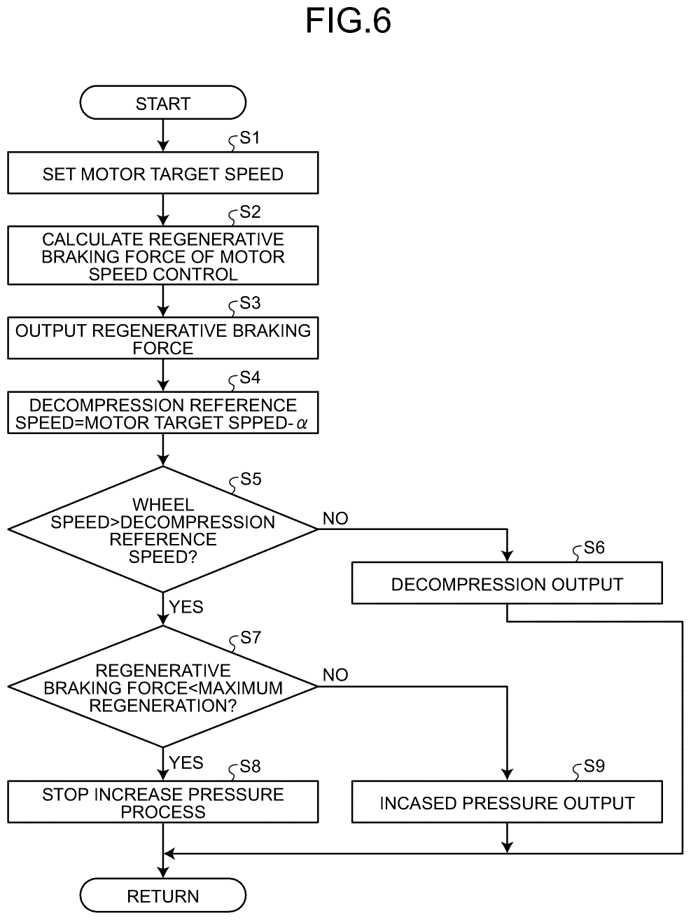

FIG. 6 is a flowchart illustrating the wheel speed control. The control illustrated in FIG. 6 is performed by the motor controller 10 and the braking controller 20 during ABS operation. In the explanation of FIG. 6, ABS operating wheel is referred to as a front wheel 4.

The braking controller 20 sets the target velocity of the motor 2 during ABS operation (step S1).

In step S1, the target speed of the motor 2 is set on the basis of the wheel speed of the wheel which is connected to the motor 2 in a power transmissible manner.

The brake controller 20 outputs a target speed to the motor controller 10, the motor controller 10 calculates the regenerative braking force of the motor speed control based on the target speed (step S2). In step S2, the regenerative braking force required to make the rotational speed of the motor 2 follow the target speed is calculated. This target velocity is calculated in step S1.

The motor controller 10 outputs a command value of the regenerative braking force (step S3). In step S3, the regenerative braking force calculated in step S2 is outputted from the motor controller 10 as a command value.

The braking controller 20 sets a decompression reference speed (step S4). In step S4, the speed obtained by subtracting the predetermined value x from the motor target speed is set to the decompression reference speed. The decompression reference speed is a value smaller than the motor target speed by a predetermined value α. The brake controller 20 in step S4 sets the decompression reference speed using the motor target speed calculated in step S1 and a predetermined value α set in advance. The predetermined value α is an offset amount to the wheel lock side with respect to the target speed.

The braking controller 20 determines whether the wheel speed is greater than the decompression reference speed (step S5). In step S5, it is determined whether or not the wheel speed of the front wheel 4 detected by the wheel speed sensor 7 is larger than the decompression reference speed set in step S4. The brake controller 20 determines the presence or absence of decompression of the hydraulic brake device by comparing the wheel speed and the decompression reference speed.

If the wheel speed is determined to be equal to or less than the decompression reference speed (No in step S5), the brake controller 20 determines that the wheel locking amount is large, and performs decompression of the hydraulic brake device (step S6). In step S6, it is determined that the road surface drag has dropped when ABS is activated, and the pressure reduction of the hydraulic braking device is started. The brake controller 20 outputs a command signal for depressurizing the hydraulic pressure of the hydraulic brake device to the hydraulic brake device. Performing the process in step S6, this control routine ends.

If the wheel speed is determined to be greater than the decompression reference speed (Yes in step S5), the braking controller 20 determines whether the regenerative braking force is less than the maximum regenerative power capable of outputting (step S7). In step S7, it is determined whether or not the regenerative braking force remains the residual force up to the maximal regeneration. The brake controller 20 calculates the maximum regeneration that can be output from the motor 2 based on the running state of the electric vehicle 1 and the charging state of the battery. The calculation method of the maximum regeneration that can be output from the motor 2 may be a known method. The brake controller 20 compares the regenerative braking force calculated by the maximum regenerative and step S2 can be outputted from the motor 2, the regenerative braking force is determined whether less than the maximum regenerative. The motor controller 10 can be outputted regenerative braking force calculated in step S2 to the braking controller 20.

If the regenerative braking force is determined to be less than the maximum regenerative power can be outputted (Yes in step S7), the brake controller 20 stops the boosting of the hydraulic brake device (step S8). In step S8, it is judged that the increase in braking force can be covered by the increase in regenerative braking force, and the increase in pressure of the hydraulic braking device is stopped. The brake controller 20 stops increasing the pressure of the hydraulic brake device by keeping the hydraulic pressure of the hydraulic brake device constant. In this case, the brake controller 20 changes only the regenerative braking force by keeping the hydraulic braking force constant. Performing the process of step S8, this control routine ends.

If it is determined that the regenerative braking force is not less than the maximum regenerative power capable of outputting (No in step S7), the brake controller 20 performs boosting of the hydraulic brake device (step S9). In step S9, it is determined that the regenerative braking force reaches the maximal regenerative power that can be outputted, and the regenerative braking force cannot be increased any more, so that the pressure increase of the hydraulic braking device is implemented. The brake controller 20 outputs a command signal to increase the hydraulic pressure of the hydraulic brake device to the hydraulic brake device. Performing the process of step S9, this control routine ends.

As described above, according to the embodiment, it is possible to prevent an increase in the wheel locking amount due to the switching delay of the hydraulic control when the road surface drag is reduced, while controlling the wheel to an appropriate slip amount with high accuracy by the regenerative braking force when ABS is operated. Thus, it is possible to prevent the running stability, the steering performance, and the feeling of deceleration of the electric vehicle 1 from deteriorating.

The electric vehicle 1 is not limited to the front-wheel drive vehicle, and may be a rear-wheel drive vehicle. The electric vehicle 1 may be a vehicle having a motor for generating a regenerative braking force to either one of the front wheels 4 and rear wheels 5.

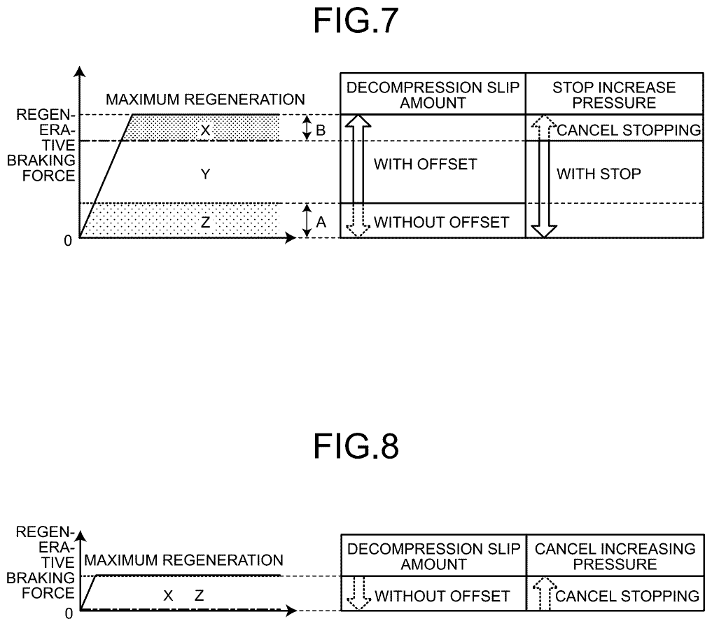

The braking control device 20 may set the decompression reference speed to the motor target speed when the regenerative braking force falls within the range close to the reduction limit during ABS operation. Further, the brake controller 20 may stop the boosting of the hydraulic brake device when the regenerative braking force is less than the range close to the maximal regenerative power capable of outputting when ABS is activated. Thus, a modification of the brake controller 20 may be configured to switch the control status in accordance with the relationship between the regenerative braking force at the time of ABS operation and the maximum regenerative power that can be output, and the relationship between the regenerative braking force and the reduction limit. It will be described with reference to FIGS. 7 to 9 for the brake controller 20 of the modified example.

As illustrated in FIG. 7, it is assumed that when the maximum regeneration is large for the regenerative braking force at the time of ABS operation, the range X, Y, Z can be divided between the maximum regeneration and zero. In this case, the regenerative braking force will enter either the range X close to the maximum regeneration, the intermediate range Y, and the range Z close to the reduction limit. Incidentally, the range X includes the case where the regenerative braking force reaches the maximum regeneration, and the range Z includes the case where the regenerative braking force reaches the reduction limit.

When the regenerative braking force is within the range X near the max. regeneration during ABS operation, the brake controller 20 offsets the decompression reference speed from the target speed to the wheel slip side by the predetermined value α and increases the pressure of the hydraulic brake device. When the regenerative braking force enters the range X close to the maximum regenerative force during motor speed control, boosting of the hydraulic brake device is started. The regenerative braking force decreases and goes out of range X (within range Y) as the hydraulic brake unit pressure increases. When the regenerative braking force changes from the range X to the range Y, the brake controller 20 stops the boosting of the hydraulic brake again and causes the wheel speed to follow the target speed only by the motor speed control (only the speed feedback control of regeneration). Thus, since a state in which the regenerative braking force cannot be increased cannot be generated when ABS is operated, it is possible to prevent the wheel velocity from being controlled only by the hydraulic control of the hydraulic braking device in a state in which the regenerative braking force cannot be increased. Therefore, the regenerative braking force is increased to the vicinity of the maximum regeneration, since the wheel slip control by the motor 2 is continued even when the region where the regenerative increase is insufficient, it does not deteriorate the controllability of the wheel slip.

When the regenerative braking force is within the intermediate range Y when ABS is activated, the brake controller 20 offsets the decompression reference speed to the wheel slip side by the predetermined value α and stops increasing the pressure of the hydraulic brake device.

If the regenerative braking force is within a range Z close to the decreasing limit when ABS is activated, the brake controller 20 adjusts the decompression reference speed to the target speed and stops increasing the pressure of the hydraulic brake device. Since the motor target speed and the decompression reference speed are the same speed, decompression of the hydraulic brake device occurs during motor speed control. When the regenerative braking force enters the range Z close to the decreasing limit during motor control, decompression of the hydraulic brake device is started. The regenerative braking force increases and goes out of the range Z (within the range Y) as the hydraulic brake unit depressurizes. When the regenerative braking force changes from the range Z to the range Y, the brake controller 20 sets the decompression reference speed to a speed that is offset to the wheel lock side than the motor target speed, and causes the wheel speed to follow the target speed only by the motor speed control (only the speed feedback control of regeneration). Thus, since a state in which the regenerative braking force cannot be reduced does not occur when ABS is operated, it is possible to prevent the wheel velocity from being controlled only by the hydraulic control of the hydraulic braking device in a state in which the regenerative braking force cannot be reduced. Therefore, since the wheel slip control by the motor 2 is continued even when the regenerative braking force is lowered to the vicinity of the reduction limit and the region where the regenerative reduction is insufficient, the controllability of the wheel slip is not deteriorated.

As illustrated in FIG. 8, it is assumed that when the maximum regeneration is small for the regenerative braking force at the time of ABS operation, the range is only the range X and the range Z between the maximum regeneration and zero. In this case, there is no intermediate range Y, so that the regenerative braking force only in the range of the range X and the range Z is entered. When the battery of the electric vehicle 1 is fully charged, or when the electric vehicle 1 is traveling at a high vehicle speed, the maximum regeneration of the regenerative braking force is reduced as shown in FIG. 8.

When the maximum regeneration is small when ABS is operating and the regenerative braking force is constantly in the range close to the maximum regeneration and the reduction limit, the brake controller 20 adjusts the decompression reference speed to the target speed and increases the pressure of the hydraulic brake device. When the maximum regeneration becomes small due to the state of the battery or the rotational speed of the motor 2 is high, the change width of the regenerative braking force becomes small, and the regenerative braking force may enter both the range X close to the maximum regeneration and the range Z close to the reduction limit. In this case, although the amount of change in the regenerative braking force is insufficient and the motor speed control alone cannot control the wheel slip, increasing and decreasing the pressure of the hydraulic brake are implemented, and the wheel slip can also be controlled by the combined hydraulic brake control.

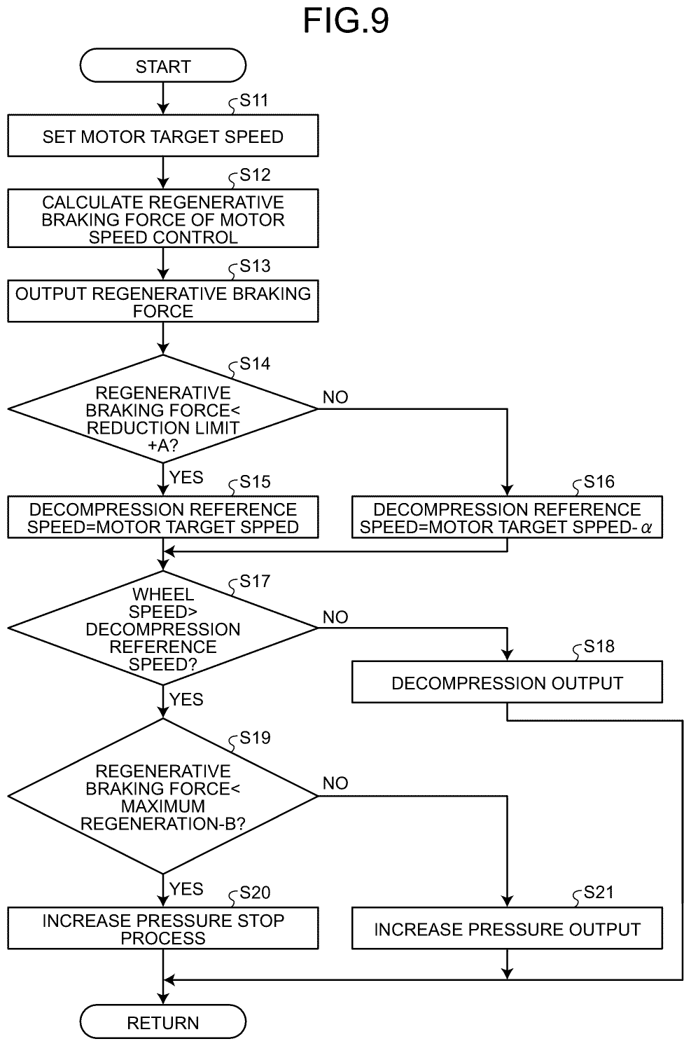

FIG. 9 is a flowchart illustrating a wheel speed control according to a modification. The control illustrated in FIG. 9 is performed by the motor controller 10 and the braking controller 20 during ABS operation. Incidentally, steps S11 to S13 description in FIG. 9 will not be described for the same process as steps S1 to S3 illustrated in FIG. 6.

After performing the process in step S13, the brake controller 20 determines whether the regenerative braking force is smaller than the value obtained by adding a predetermined value A to the decreasing limit of the regenerative braking force (step S14). The predetermined value A, as illustrated in FIG. 7, is a value that defines a range Z close to the decrease limit of the regenerative braking force. In step S14, it is determined whether or not the regenerative braking force is in the area Z illustrated in FIG. 7.

If it is determined that the regenerative braking force is smaller than the value obtained by adding the predetermined value A to the decreasing limit of the regenerative braking force (Yes in step S14), the brake controller 20 sets the decompression reference speed to the same value as the motor target speed (step S15). In step S15, it is determined that the reduction of the regenerative braking force is not possible in a short time, and the motor target speed is set to the decompression reference speed. The brake controller 20 determines that the regenerative braking force is in the range Z illustrated in FIG. 7 and adjusts the decompression reference speed to the target speed.

If it is determined that the regenerative braking force is equal to or more than a value obtained by adding a predetermined value A to the decreasing limit of the regenerative braking force (No in Step S14), the brake controller 20 sets the decompression reference speed to a value obtained by subtracting the predetermined value x from the motor target speed (Step S16). In step S16, the increment of the braking force is determined to be enabled by the regenerative braking force, and a value obtained by subtracting the predetermined value x from the motor target speed is set to the decompression reference speed. The brake controller 20 determines that the regenerative braking force is in the range X or the range Y illustrated in FIG. 7, and offsets the decompression reference speed from the target speed by a predetermined value α to the wheel slip side.

After performing the process in step S15 or S16, the braking controller 20 determines whether the wheel speed is greater than the decompression reference speed (step S17). It is determined whether or not the wheel speed is larger than the decompression reference speed (=motor target speed) set in step S15 when the process proceeds from step S15 to step S17. It is determined whether or not the wheel speed is larger than the decompression reference speed (=motor target speed-a) set in step S16 when the process proceeds from step S16 to step S17.

If the wheel speed is determined to be equal to or less than the decompression reference speed (No in step S17), the brake controller 20 determines that the wheel locking amount is large, and performs decompression of the hydraulic brake device (step S18). If step S18 is performed after step S15 is performed, decompression of the hydraulic braking device is started with the regenerative braking force entering the area Z illustrated in FIG. 7. If step S18 is performed after step S16 is performed, decompression of the hydraulic braking device is started with the regenerative braking force being applied to the range X or the range Y state in FIG. 7. When the process of step S18 is performed, the control routine is terminated.

If the wheel speed is determined to be larger than the decompression reference speed (Yes in step S17), the braking control device 20 determines whether the regenerative braking force is smaller than the value obtained by subtracting the predetermined value B from the maximum regenerative force capable of outputting (step S19). The predetermined value B, as illustrated in FIG. 7, is a value that defines a range X close to the maximum regeneration. In step S19, it is determined whether or not the regenerative braking force is outside the area X illustrated in FIG. 7.

If the regenerative braking force is determined to be less than the value obtained by subtracting the predetermined value B from the maximum regeneration capable of outputting (Yes in step S19), the brake controller 20 stops the boosting of the hydraulic brake device (step S20). In step S20, it is judged that the increase in braking force can be covered by the increase in regenerative braking force, and the increase in pressure of the hydraulic braking device is stopped. The brake controller 20 determines that the regenerative braking force is in the range Y or the range Z illustrated in FIG. 7 and stops increasing the pressure of the hydraulic brake device. When step S20 is performed after step S15 is performed, the boosting of the hydraulic braking device is stopped with the regenerative braking force entering the area Z illustrated in FIG. 7. When step S20 is performed after step S16 is performed, the boosting of the hydraulic braking device is stopped with the regenerative braking force entering the area Y illustrated in FIG. 7. When the process of step S20 is performed, the control routine is terminated.

If the regenerative braking force is determined to be equal to or greater than the value obtained by subtracting the predetermined value B from the maximum regenerative capable of outputting (No in step S19), the brake controller 20 performs boosting the pressure of the hydraulic brake device (step S21). In step S21, the increment of the regenerative braking force is judged to be impossible in a short time, and the boosting of the hydraulic braking device is implemented. The brake controller 20 determines that the regenerative braking force is in the range X illustrated in FIG. 7, to implement the pressure increase by releasing the boost stop of the hydraulic brake device. After performing the process of step S21, this control routine ends.

According to the modification, the hydraulic brake device is operated to the minimum in accordance with the regenerative braking force, so that the motor speed control can be used in a large amount, and the hydraulic control of the hydraulic brake device can be operated in the case where the amount of change in the braking force is insufficient only by the motor speed control. Thus, it is possible to cope with a delay in switching the hydraulic control of the hydraulic brake device while controlling the appropriate slip amount with high accuracy by the regenerative braking force. Therefore, it is possible to prevent a decrease in the running stability of the electric vehicle 1, a decrease in the steering response, and a decrease in the feeling of deceleration.

The reduction limit of the regenerative braking force is not limited to zero. For example, a value around zero can be set to the reduction limit of the regenerative braking force.

In the present disclosure, it is possible to prevent the reduction of the braking force from being delayed even when the road surface drag decreases during ABS operation, thereby ensuring the running stabilities.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A controller for an electric vehicle for executing anti-lock control for suppressing a lock of a wheel by controlling a braking force applied to the wheel using a hydraulic braking force by a hydraulic brake device and a regenerative braking force by a motor, wherein
the controller is configured to
control to set a first state where the regenerative braking force is controlled by speed feedback control in which a hydraulic pressure of the hydraulic brake device, during execution of the anti-lock control, is set constant and a speed of the wheel is controlled to follow a target speed,
determine whether a road surface resistance is lower than a predetermined value during the control to the first state, and
reduce, when determining that the road surface resistance is lower than the predetermined value in the first state, the hydraulic pressure of the hydraulic brake device while controlling the regenerative braking force by the speed feedback control.

2. The controller for an electric vehicle according to claim 1, wherein
the controller is configured to
set a decompression reference speed to reduce the hydraulic pressure of the hydraulic brake device in the first state,
determine, under control to the first state, whether a rotation speed of the wheel is greater than the decompression reference speed,
determine, when determining that the rotation speed of the wheel is equal to or less than the decompression reference speed in the first state, that the road surface resistance is less than a predetermined value under the control to the first state, and
start decompression of the hydraulic brake device before the regenerative braking force reaches a reduction limit.

3. The controller for an electric vehicle according to claim 1, wherein
the controller is configured to
set the decompression reference speed to a value that is obtained by subtracting a preset value from a target speed of the motor,
set a control value of the hydraulic pressure of the hydraulic brake device according to a magnitude of the road surface resistance,
perform control so that the hydraulic pressure of the hydraulic brake device is constant at the control value of the hydraulic pressure in the first state, and
reset the control value of the hydraulic pressure in accordance with the reduced road surface resistance and continue the control of the regenerative braking force by the speed feedback control when determining that the rotation speed of the wheel is equal to or less than the decompression reference speed in the first state.

4. The controller for an electric vehicle according to claim 2, wherein
the controller is configured to
determine whether the regenerative braking force is in a preset range including the reduction limit of the regenerative braking force during the control to the first state, and
set, when determining that the regenerative braking force is in the preset range including the reduction limit, the decompression reference speed to a same value as the target speed of the motor.

5. The controller for an electric vehicle according to claim 4, wherein
the controller is configured to
determine whether the regenerative braking force is in a prescribed range including a maximum regeneration which the regenerative braking force can output during the control to the first state, and
increase, when determining that the regenerative braking force is in the prescribed range including the maximum regeneration, the hydraulic pressure of the hydraulic brake device.
